(19) United States
(12) Patent Application Publication
(10) Pub. No.: US 2013/0069533 A1
(43) Pub. Date: Mar. 21, 2013

(54) SEMICONDUCTOR LAMP AND METHOD FOR OPERATING A SEMICONDUCTOR LAMP

(71) Applicants: Steffen Tegethoff, Pentling (DE); Thomas Preuschl, Sinzing (DE)

(72) Inventors: Steffen Tegethoff, Pentling (DE); Thomas Preuschl, Sinzing (DE)

(73) Assignee: OSRAM AG, Muenchen (DE)

(21) Appl. No.: 13/699,625

(22) PCT Filed: Apr. 18, 2011
(86) PCT No.: PCT/EP2011/056169

§ 371 Date: Nov. 22, 2012

(30) Foreign Application Priority Data
May 25, 2010 (DE) 10 2010 029 249.4

(51) Int. Cl. H05B 37/02; H05B 33/08; H05B 37/00

(52) U.S. Cl. 315/113; 315/312; 315/210

(57) ABSTRACT

A semiconductor lamp may include at least one semiconductor light source and a driver for feeding the at least one semiconductor light source, wherein the driver is inductively coupled to the at least one semiconductor light source at least for the feeding.

The invention relates to a semiconductor lamp, in particular an LED lamp, having at least one light source substrate equipped with at least one semiconductor light source, wherein the at least one light source substrate is arranged on an outer surface of the heat sink, and a heat sink having a driver cavity, wherein at least one driver for supplying the at least one semiconductor light source with power is arranged in the driver cavity. The invention also relates to a method for operating a semiconductor lamp, wherein power is transmitted from a driver to at least one semiconductor light source.

WO 2004/097866 A1 describes a device for supplying energy to a load and an associated system, wherein the device for supplying energy to a load has a power supply, e.g., a switched electronic transformer or electronic ballast having an input for receiving a current at a grid frequency and a means for elevating the grid frequency to a higher frequency, e.g., 30 to kHz, and an output for delivering energy at the higher frequency. A two-part plug has a first core part, which has a primary winding, which is connected to the output of the power supply unit, and an opposing core part, which has a secondary winding for delivering energy to a load, wherein the core parts consist of a material having high resistance, e.g., a ferrite. The device may be used for the purpose of operating, e.g., a low-voltage halogen or other incandescent light, a fluorescent light or an electric motor, a power supply for a computer, a radio, a television, or a similar electronic device, a heating device, or the like. In other words, the device includes a two-part induction plug for coupling energy from a single primary plug to one or more secondary plug(s), wherein one or more electrical devices, such as a lamp, are electrically connected to the or each secondary plug. Alternative electrical units or devices may have installed secondary devices for direct inductive coupling with a primary plug.

It is the object of the present invention to provide a semiconductor lamp, in particular an LED lamp, having improved security from electrical shock and having a simplified structure.

This object is achieved according to the features of the independent claims. Preferred embodiments can be inferred in particular from the dependent claims.

The object is achieved by a semiconductor lamp, having at least one semiconductor light source and one driver for feeding the at least one semiconductor light source, wherein the driver is inductively coupled to the at least one semiconductor light source at least for the feeding.

Because the driver is now no longer galvanically connected via electrical lines to the light source substrate (and therefore electrically to the at least one semiconductor light source), but rather is connected in a galvanically separated manner via a magnetic alternating field, savings of solder points or other types of contacts such as plug connections result and therefore a lower production outlay, in particular also a smaller material parts list. In addition, it is possible to eliminate the danger of a user receiving an electrical shock, in particular from a grid voltage, when touching an external current-conducting region of the semiconductor lamp in the event of a fault. In addition, the at least one semiconductor light source can be operated using a low voltage or a safety extra-low voltage without any additional structural outlay or a safety disadvantage, while the driver is operated using a higher voltage, e.g., using a grid voltage, e.g., of 110 V or 230V. The driver can thus be operated at a higher efficiency.

Alternatively, the driver can also be operated at a low voltage (possibly lower than the grid voltage), e.g., of 12 V, which results in a safety advantage. The powering of the driver using a low voltage can be advantageous, for example, if the semiconductor lamp is a halogen lamp retrofit lamp, e.g., having a base of the type GU10, MR11, or MR16.

The at least one semiconductor light source preferably includes at least one light-emitting diode. If multiple light-emitting diodes are provided, they may emit light in the same color or in different colors. A color can be monochromic (e.g., red, green, blue, etc.) or multi-chromic (e.g., white). The light emitted by the at least one light-emitting diode can also be an infrared light (IR LED) or an ultraviolet light (UV LED). Multiple light-emitting diodes can generate a mixed light; e.g., a white mixed light. The at least one light-emitting diode can contain at least one wavelength-converting fluorescent material (conversion LED). The at least one light-emitting diode can be provided in the form of at least one individually housed light-emitting diode or in the form of at least one LED chip. Multiple LED chips can be installed on a common substrate (“submount”). The at least one light-emitting diode can be equipped with at least one separate and/or shared optic for beam guiding, e.g., at least one Fresnel lens, collimator, etc. Instead of or in addition to inorganic LEDs, e.g., based on InGaN or AlInGaP, in general organic LEDs (OLEDs, e.g., polymer OLEDs) are also usable. Alternatively, the at least one semiconductor light source can have, e.g., at least one diode laser.

In one embodiment,
the at least one semiconductor light source is arranged on a light source substrate,
the at least one light source substrate is arranged on an outer support surface of a heat sink, and
the heat sink has a driver cavity, in which an electrically insulated driver housing is located, wherein the driver is housed in the driver housing.

This embodiment provides a further simplified structure and still higher operational reliability. The equipped light source substrate thus only still needs to be laid on the heat sink and optionally fastened thereon. Post-processing of the equipped light source substrate, e.g., by electrical contacting, can be omitted. In addition, by enclosing the driver in the driver housing, the danger can be precluded of a user receiving an electrical shock, in particular from a grid voltage, when touching an external current-conducting region of the light source substrate (also called a “light engine”) equipped with the at least one semiconductor light source in the event of a fault. The user also cannot touch the driver or parts thereof in another manner. The equipped light source substrate can also be operated using a low voltage or a safety extra-low voltage without any additional structural outlay or a safety disadvantage, while the driver is operated using a higher voltage, e.g., using a grid voltage.

In another embodiment, the driver has at least one first coil or is electrically coupled thereto and the light source substrate has at least one second coil or is electrically coupled thereto. Instead of a transformer, two discrete insulated coils are therefore used for the transmission. A compact, simple to implement, and effective inductive coupling may thus be achieved. The first coil can therefore be a part of the driver (e.g., attached on a driver circuit board) or can be coupled to the driver. The second coil can also be attached to the light source substrate or can be electrically coupled to the light source substrate while positioned spaced apart therefrom. The at least one first coil and the at least one second coil are galvanically and mechanically separated by the driver housing.

In another embodiment,
the heat sink has a connecting channel, which connects the driver cavity to the support surface of the heat sink,
the driver housing extends by means of an extension at least up into the connecting channel, and
the first coil is at least partially arranged in the extension.

This embodiment is particularly simply implementable, since only the connecting channel has to be introduced into the heat sink and the shape of the driver housing has to be slightly adapted. Through the at least partial arrangement of the first coil in the extension, the first coil is moved closer to the light source substrate and higher efficiency of the coupling is thus made possible.

In another embodiment, which is advantageous for high efficiency of the coupling, the light source substrate overlaps the connecting channel and the second coil is arranged opposite to the connecting channel on the light source substrate, i.e., above the opening on a front side of the light source substrate, when the light source substrate is fastened using its rear side on the heat sink. A particularly small distance (minimally of the thickness of the light source substrate) between the first coil and the second coil can thus be achieved using a typical light source substrate which is not machined for this purpose, which allows high efficiency of the coupling.

Furthermore, in one embodiment, the extension protrudes through the heat sink and through the light source substrate, the first coil is arranged in the extension so that it is arranged at least partially coplanar to the second coil, and the second coil substantially peripherally encloses the first coil. The extension can be, e.g., a hollow cylindrical extension, which is simple to produce and can be guided through the heat sink and through the light source substrate. The extension protrudes beyond the light source substrate, so that the first coil located therein can be positioned at least partially at an equal height (coplanar) as a second coil attached to the light source substrate. This also results in particularly effective coupling. The first coil is still galvanically and mechanically separated by means of the driver housing from the equipped light source substrate and the heat sink.

In another embodiment, the light source substrate overlaps the connecting channel, the second coil is integrated in the light source substrate, and the second coil is arranged substantially concentrically peripherally around the connecting channel. A still smaller distance and still more effective coupling can thus be achieved. The second coil does not need to extend radially around the opening, but rather can be spaced apart therefrom with respect to a position in a longitudinal direction extending through the opening. The light source substrate does not have to be machined for the introduction or feedthrough of the extension, which saves production costs.

Alternatively, the light source substrate can have a borehole for inserting the extension, which is enclosed by the second coil, so that the first coil and the second coil can be arranged in a substantially coplanar manner. This embodiment is particularly compact and effective.

In another embodiment, the light source substrate has been produced using LTCC technology. A second coil, which is integrally embedded in the light source substrate, may thus be implemented particularly simply and robustly.

In still another embodiment, the first coil represents a part of a primary side of a power transfer circuit, wherein the primary side is connectable to a grid supply and is configured for the purpose of transforming an AC voltage of the grid supply into a feed (AC) voltage having a higher frequency, wherein the first coil is fed by means of the feed voltage. The coils can be made more compact due to the higher frequency.

In still a further embodiment, the feed voltage has a frequency between approximately 20 kHz and 300 MHz, in particular between approximately 1 MHz and 300 MHz, in particular between approximately 100 MHz and 300 MHz. This results in a good compromise between an apparatus expenditure and a compact structure.

The primary-side power transfer circuit can particularly have a first part, which is connectable to a grid supply, and which transforms the grid voltage into a DC voltage. The first part can be provided, e.g., in the form of a rectifier, e.g., an electronic component. The rectifier can be or include, e.g., a bridge circuit. The primary-side power transfer circuit can also have a second part, which is connected downstream from the first part, for smoothing the rectified voltage, e.g., a smoothing capacitor. The primary-side power transfer circuit can also have a third part, which is connected downstream from the second part, for transforming the smoothed rectified voltage into an AC voltage. The third part can be provided, e.g., in the form of an inverter, e.g., an electronic component. The primary-side power transfer circuit can be provided as a whole (except for the first coil) in the form of an electrical or electronic component.

In still another alternative embodiment, the first coil is electrically directly connectable to a grid supply, the at least one semiconductor light source is electrically directly connectable to the second coil, and the at least one semiconductor light source is a semiconductor light source capable of grid operation. In this case, current or voltage transformation per se can be omitted, which simplifies a structure.

In an additional further development, a rectifier is connected downstream from the second coil. A smoothing element, e.g., a smoothing capacitor, can be connected downstream from the rectifier.

The object is also achieved by a method for operating a semiconductor lamp, wherein power is transmitted inductively from a driver to at least one semiconductor light source.

In a further development, a first coil, which is electrically connected to the driver, generates a magnetic alternating field at the location of a second coil, which is electrically connected to the semiconductor light source, wherein the magnetic alternating field is built up through an electrically nonconductive separating element, e.g., a driver housing, between the first coil and the second coil.

In still another further development, to operate the first coil
a grid voltage is transformed into a DC voltage,
the transformed DC voltage is smoothed, and
the smoothed DC voltage is transformed into an AC voltage to feed the first coil,
wherein the AC voltage for feeding the first coil has a higher frequency than the grid voltage.

In another further development, an induction voltage tapped at the second coil is at least partially rectified to operate the second coil.

In the following figures, the invention is schematically described in greater detail on the basis of exemplary embodiments. Identical or identically acting elements can be provided with identical reference numerals for comprehensibility.

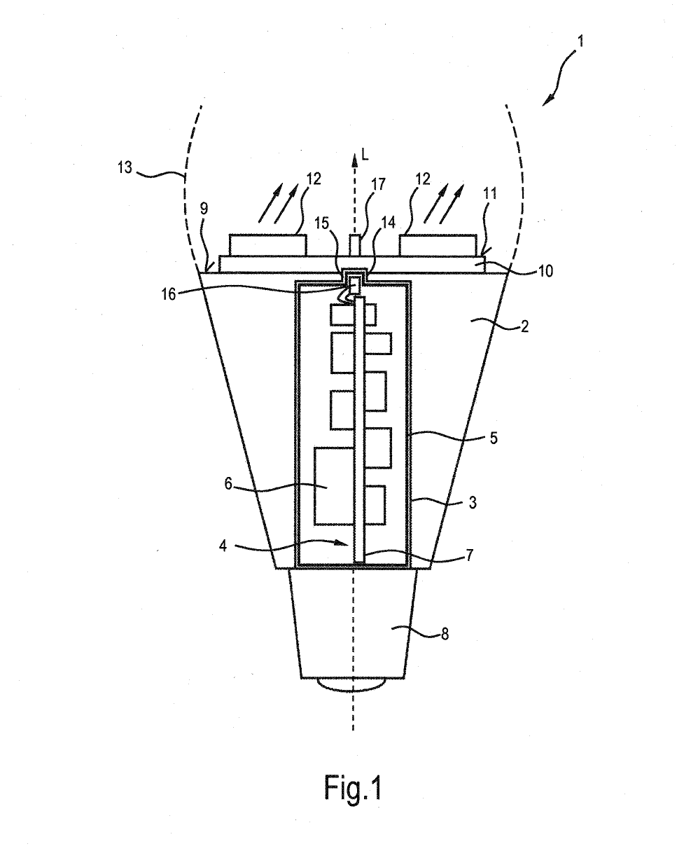

FIG. 1 shows a sectional illustration in a side view of a semiconductor lamp according to a first embodiment;

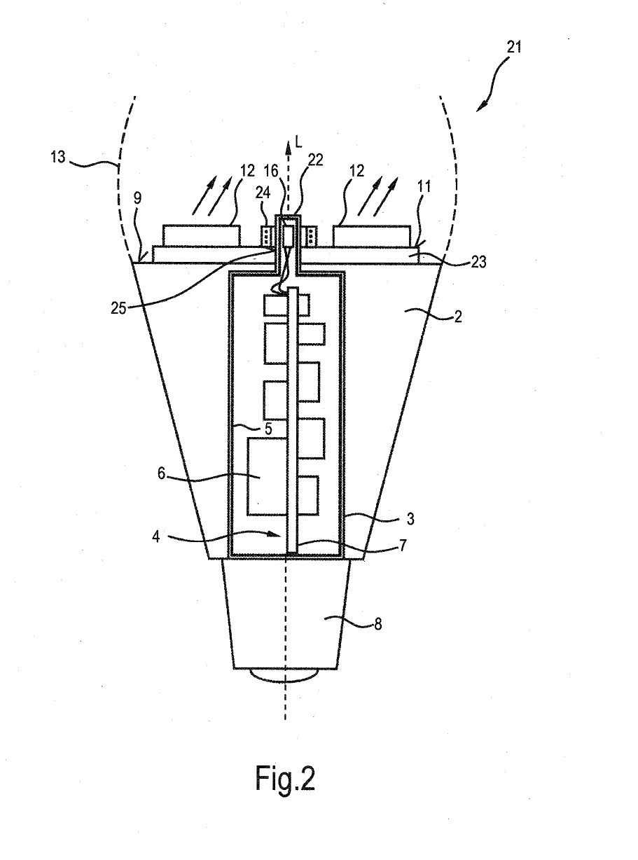

FIG. 2 shows a sectional illustration in a side view of a semiconductor lamp according to a second embodiment;

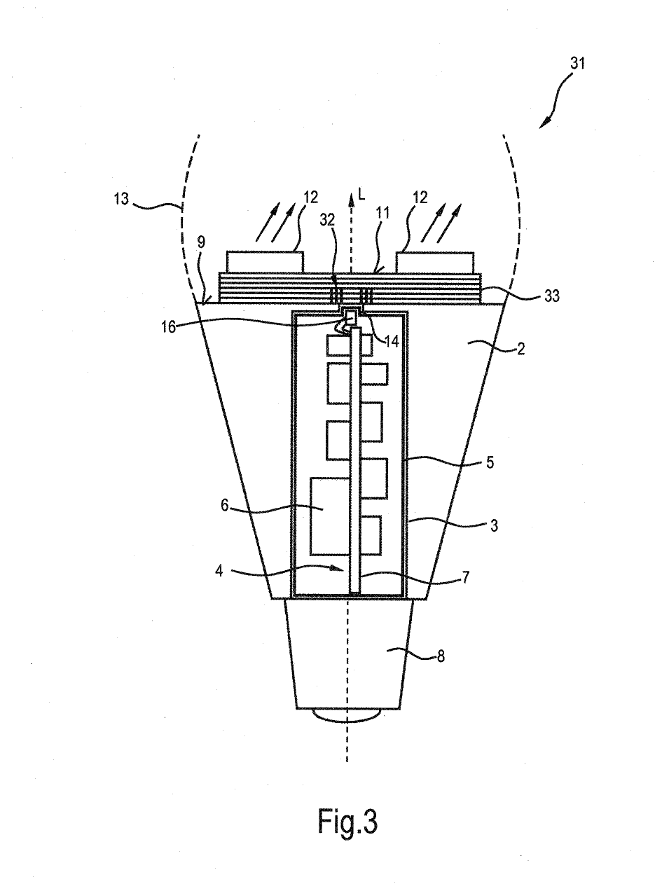

FIG. 3 shows a sectional illustration in a side view of a semiconductor lamp according to a third embodiment; and

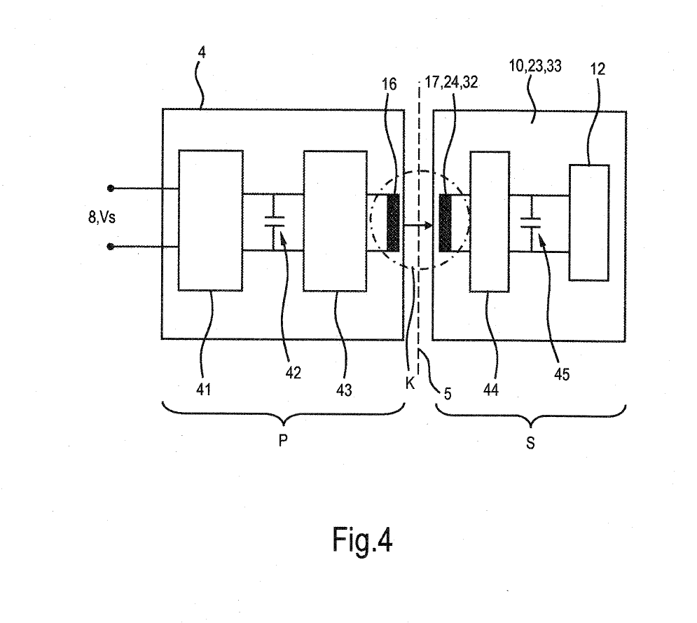

FIG. 4 shows an outline of the inductive coupling between a driver and a semiconductor light source of the semiconductor lamps according to FIG. 1 to FIG. 3.

FIG. 1 shows a semiconductor lamp 1, which is usable as an incandescent lamp retrofit lamp, which has an outer contour that is substantially symmetrical around a longitudinal axis L. The semiconductor lamp 1 has a heat sink 2, which has a driver cavity 3 for receiving a driver 4. An electrically insulating driver housing 5, e.g., made of plastic, is arranged in the driver cavity 3, which housing in turn receives the driver 4. The driver 4 is implemented here in the form of a driver substrate 7, which is equipped on both sides with driver components 6. On its rear end, the driver cavity 3 or the driver housing 5, respectively, is closed or covered by a base 8, wherein the base 8 is provided to engage in an electrical socket. The base 8 can be a bayonet base or Edison base, for example. The rear side of a light source substrate 10 rests flatly on a level front side 9 of the heat sink 2. Multiple semiconductor light sources in the form of light-emitting diodes 12 are located on a front side 11 of the light source substrate 10. The light-emitting diodes 12 emit essentially in a front half-space and are overlapped by a bulb, which is fastened on the heat sink 2. The bulb 13 can be transparent or opaque, for example, wherein in particular the opaque bulb 13 can be used as a diffuser to homogenize a light emission of the light-emitting diodes 12.

The driver cavity 3 is connected via a connecting channel 14, which lies concentric to the longitudinal axis L, to the front side 9 of the heat sink 2. The driver housing 5 forms a hollow-cylindrical extension 15, which is inserted into the connecting channel 14, on its front side oriented toward the light source substrate 10. The connecting channel 14 and therefore also the extension 15 are covered by the light source substrate 10. To feed or supply the light-emitting diodes 12, the driver 4 has a first coil 16, which is electrically connected to the driver substrate 7 and is at least partially arranged in the extension 15. A second coil 17 is arranged collinear to the first coil 16 on the front side 11 of the light source substrate 10. Both coils 16, 17 lie centered to the longitudinal axis L and are substantially only separated from one another by the light source substrate 10. A smaller distance thus results between the coils 16, 17. To feed the light-emitting diodes 12, the first coil 16 is supplied with an AC voltage by means of the driver 4, so that the first coil 16 generates a magnetic alternating field. Since the driver housing 5 and the light source substrate 10 do not substantially shield this magnetic alternating field, i.e., are substantially transmissive for the magnetic alternating field, e.g., through the use of typical substrate materials such as FR4, ceramic, etc. for the light source substrate 10 and a plastic for the driver housing 5, the magnetic alternating field generates an induction voltage at the location of the second coil 17, which is tapped to operate the light-emitting diodes 12.

Since the induction voltage is typically an AC voltage, the light-emitting diodes 12 can be designed, for example, to be capable of grid connection and can be directly operated using the induction voltage. Alternatively, a rectifier (not depicted) can be connected downstream from the second coil, which allows DC operation of the light-emitting diodes 12. A smoothing means, e.g., a smoothing capacitor, can be connected downstream from the rectifier, in particular to allow a substantially continuous feed of the light-emitting diodes 12, which only varies slightly or not at all. As a whole, the first coil 16 and the second coil 17 as well as their arrangement can be designed so that the light-emitting diodes 12 can be operated using a suitable form and strength of a current or a voltage. In other words, the two coils 16, 17 operate like galvanically separated transformer halves, so that advantageously a direct electrical contact of the driver 4 to the light source substrate 10 or the light-emitting diodes 12 can be omitted. Direct passages between the driver cavity 3 and an outer side of the light source substrate 10 can thus also be avoided, so that air and creepage distances are reliably maintained or are not relevant here. The electrically and mechanically insulating driver housing 5 shields the driver 4 completely in relation to the light source substrate 10. The driver 4 can thus be operated in particular using a high voltage delivered via the base 8, e.g., the grid voltage, while the light-emitting diodes 12 can be operated using a low voltage or a safety extra-low voltage. The structure of the semiconductor lamp 1 is simplified overall in relation to previous electrical contacting, and secondly the user safety is improved.

FIG. 2 shows a semiconductor lamp 21 similar to the semiconductor lamp 1, except that now the extension 22 protrudes through the heat sink 2 and through the light source substrate 23, the first coil 16 is arranged in the extension 22 so that it is arranged at least partially coplanar (in a plane perpendicular to the longitudinal axis L) to the second coil 24, and the second coil 24 substantially peripherally encloses the first coil 16. The second coil 24 is therefore implemented as a ring which substantially concentrically encloses the first coil 16, and which can include multiple windings. Because of the small distance and the high cross section for the magnetic flux on the second coil 17, very good inductive coupling results. For this embodiment, the light source substrate 23 has a perpendicular borehole 25, which is arranged collinear to the connecting channel 14 along the longitudinal axis L.

FIG. 3 shows a semiconductor lamp 31 similar to the semiconductor lamp 1. The heat sink 2, the driver 4, and the first coil 16 are implemented as in the semiconductor lamp 1. In contrast, a second coil 32 is now integrated in the light source substrate 33, whereby it is positioned closer to the first coil 16. In addition, the second coil 32 is now arranged extending substantially concentrically, although not coplanar as in the semiconductor lamp 21, around the connecting channel 14, which still allows a high cross section for the magnetic flux on the second coil 32. Overall, very effective transformational or inductive coupling also results in this embodiment.

To implement the integration, in particular in one piece, of the second coil 32 in the light source substrate 33, this substrate can be produced as a multilayer substrate using LTCC (“low temperature cofired ceramics”) technology.

FIG. 4 shows an outline of a possible embodiment of an inductive coupling between the driver 4 and the semiconductor light source 12 of the semiconductor lamps 1, 21, and/or 31 (“coupling circuit”). The driver 4 represents a primary side P of the coupling circuit with the coil 16, while the second coil 17, 24, or 32, respectively, having the elements connected downstream therefrom, which are arranged on or in the light source substrate 10, 23, 33, represents a secondary side S of the coupling circuit. The primary side P and the secondary side S are galvanically separated from one another by the electrically insulating driver housing 5. The driver housing 5 is substantially transmissive for the magnetic alternating field existing between the first coil 16 and the second coil 17, 24, or 32. The primary side P has a grid connection with the base 8, which can deliver a grid voltage Vs, e.g., at a frequency between approximately 50 Hz and 60 Hz.

A rectifier 41 is connected to the base 8 or the grid connection, respectively, e.g., in the form of a bridge rectifier (half bridge, full bridge, etc.) or another rectifier. A smoothing capacitor 42 is connected downstream from the rectifier 41, to smooth the possibly pulsing DC voltage output through the rectifier 41. An inverter 43 is in turn connected downstream from the smoothing capacitor 42, which transforms the smoothed DC voltage signal into an AC voltage to feed the first coil 16 (coil feed voltage). The coil feed voltage can have a different, in particular lower voltage level than the grid voltage, but a higher frequency (e.g., in a frequency range between 20 kHz and 300 MHz). The first coil 16 can be implemented in a particularly compact manner owing to the higher frequency.

The first coil 16 operated by means of the coil feed voltage generates a magnetic alternating field at the location of the second coil 17, 24, 32, so that an induction voltage is generated in the second coil 17, 24, 32. The second coil 17, 24, 32 can also be implemented in a compact manner because of the high frequency of the magnetic alternating field. A rectifier 44 is connected downstream from the second coil 17, 24, 32, e.g., in the form of a bridge rectifier (half bridge, full bridge, etc.) or another rectifier. A smoothing capacitor 45 is connected downstream from the rectifier 44, to smooth the possibly pulsing DC voltage output by the rectifier 44. The at least one light-emitting diode 12 is in turn attached as the load to the smoothing capacitor 45.

The elements 41, 42, 43 of the primary side P can each or in combination be provided in the form of an integrated circuit, as can the elements 44 and 45 of the secondary side S.

Of course, the present invention is not restricted to the exemplary embodiments shown.

Thus, features of the embodiments shown can also be mixed, omitted, or exchanged. For example, the light source substrate 33 of the semiconductor lamp 31 can have a recess open at the rear or a feedthrough similar to the perpendicular borehole 25, wherein the first coil 16 is arranged coplanar to the second coil 32, however. The extension can only extend into the light source substrate 33, or also forward beyond it, for this purpose.

Furthermore, the coils and the extension can also be arranged off-center having a lateral distance to the longitudinal axis L.

The first coil, even without use of a driver, can also be electrically directly connected to the base or the grid voltage, respectively, and the at least one semiconductor light source can be directly connected to the second coil.

Moreover, an information signal can also be inductively transmitted in addition to a power signal, both unidirectionally or bidirectionally, e.g., by means of a PLC (“power line communication”) technology. The information signal can be used, e.g., for dimming the semiconductor lamp, e.g., via a secondary-side circuit connected to the semiconductor light sources. The information transmission can also be carried out via separate data transmission coils, e.g., having a winding.

In general, the coils can have a core, e.g., made of ferrite.

### LIST OF REFERENCE NUMERALS

1 semiconductor lamp
2 heat sink
3 driver cavity
4 driver
5 driver housing
6 driver component
7 driver substrate
8 base
9 front side of the heat sink
10 light source substrate
11 front side of the light source substrate
12 light-emitting diode
13 bulb
14 connecting channel
15 extension
16 first coil
17 second coil
21 semiconductor lamp
22 extension
23 light source substrate
24 second coil
25 borehole
31 semiconductor lamp
32 second coil
33 light source substrate
41 rectifier
42 smoothing capacitor
43 inverter
44 rectifier
45 smoothing capacitor
L longitudinal axis
P primary side
S secondary side
Vs grid voltage

1. A semiconductor lamp, comprising
at least one semiconductor light source and a driver for feeding the at least one semiconductor light source,
wherein the driver is inductively coupled to the at least one semiconductor light source at least for the feeding.

2. The semiconductor lamp as claimed in claim 1, wherein
the at least one semiconductor light source is arranged on a light source substrate,
the at least one light source substrate is arranged on an outer support surface of a heat sink, and
the heat sink comprises a driver cavity, in which an electrically insulating driver housing is located, wherein the driver is housed in the driver housing.

3. The semiconductor lamp as claimed in claim 2, wherein the driver comprises at least one first coil or is electrically coupled thereto and the light source substrate comprises at least one second coil or is electrically coupled thereto.

4. The semiconductor lamp as claimed in claim 3, wherein
the heat sink comprises a connecting channel, which connects the driver cavity to the support surface of the heat sink,
the driver housing extends by means of an extension at least up into the connecting channel, and
the first coil is at least partially arranged in the extension.

5. The semiconductor lamp as claimed in claim 4, wherein the light source substrate overlaps the connecting channel and the second coil is arranged opposite to the connecting channel on the light source substrate.

6. The semiconductor lamp as claimed in claim 4, wherein
the extension protrudes through the heat sink and through the light source substrate,
the first coil is arranged in the extension so that it is arranged at least partially coplanar to the second coil, and
the second coil substantially peripherally encloses the first coil.

7. The semiconductor lamp as claimed in claim 4, wherein
the light source substrate overlaps the connecting channel,
the second coil is integrated in the light source substrate, and
the second coil is arranged substantially peripherally concentrically around the connecting channel.

8. The semiconductor lamp as claimed in claim 7, wherein the light source substrate has been produced using LTCC technology.

9. The semiconductor lamp as claimed in claim 3, wherein the first coil represents a part of a primary side of a power transfer circuit, wherein the primary side is connectable to a grid supply and is configured for the purpose of converting an AC voltage of the grid supply into a feed voltage having a higher frequency, in particular between approximately 20 kHz and 300 MHz, wherein the first coil is fed by means of the feed voltage.

10. The semiconductor lamp as claimed in claim 3, wherein
the first coil is electrically directly connectable to a grid supply,
the at least one semiconductor light source is electrically directly connectable to the second coil, and
the at least one semiconductor light source is a semiconductor light source capable of grid operation.

11. A method for operating a semiconductor lamp, comprising transmitting power inductively from a driver to at least one semiconductor light source.

12. The method as claimed in claim 11, further comprising generating via a first coil, which is electrically connected to the driver, a magnetic alternating field at the location of a second coil, which is electrically connected to the semiconductor light source, wherein the magnetic alternating field is built up through an electrically nonconductive separating element between the first coil and the second coil.

13. The method as claimed in claim 11, further comprising operating the first coil by
transforming a grid voltage into a DC voltage,
smoothing the transformed DC voltage, and
transforming the smoothed DC voltage into an AC voltage to feed the first coil,
wherein the AC voltage for feeding the first coil has a higher frequency than the grid voltage.

14. The method as claimed in claim 11, further comprising rectifying, at least partially, an induction voltage tapped at the second coil to operate the second coil.
